(19) United States
(12) Patent Application Publication
(10) Pub. No.: US 2004/0103026 A1
(43) Pub. Date: May 27, 2004

(54) Method of and apparatus for designing advertisements by using digital media assets

(76) Inventor: Richard Mark White, Kent (GB)

Correspondence Address: Richard C Woodbridge, Woodbridge & Associates, PO Box 592, Princeton, NJ, 08542-0592, US

(21) Appl. No.: 10/398,071

(22) PCT Filed: Oct. 3, 2001
(86) PCT No.: PCT/GB01/04404

(30) Foreign Application Priority Data
Oct. 3, 2000 (GB) 0024167.9

(51) Int. Cl. G06F 17/60

(52) U.S. Cl. 705/14

(57) ABSTRACT

A central web server is provided which stores tens or hundreds of thousands of media assets (such as still photographs, video, logos, advertising text, etc.) in a database which can be accessed over the internet by any number of authorised persons, each with a computer using a standard web browser. The central web server is programmed to allow not only the creation of an advertisement on-line through the selection, assembly or modification of appropriate media assets, with a realistic on-screen simulation of how the published advertisement will look, but also the actual delivery of the media assets to for example, a magazine publisher or television station. By integrating the media asset delivery process into the on-line advertisement creation process, a fully integrated system is produced which greatly increases the efficiency of the management and production of advertising campaigns.

### BACKGROUND TO THE INVENTION

1. Field of the Invention

This invention relates to a method of and apparatus for designing advertisements by using digital media assets.

2. Description of the Prior Art

During the last decade, the advertising industry has witnessed a significant increase in the globalisation of brands, so that in 2000 over one hundred multinationals each spent more than $500 million on advertising. This vast market for international advertising has been mostly serviced through multi-national advertising agencies, since only they have been seen as being able to manage and produce fully co-ordinated international advertising campaigns.

However, the management and production of international advertising campaigns remains very inefficient. Current advertising management and production methods are generally based on early 1990s technology and processes. Whilst some multi-national advertising agencies use intranets and internal e-mail systems, their general lack of willingness to invest in technology means that they are not exploiting the benefits that technology could bring. They are in fact direct beneficiaries of the inefficiencies of outdated systems: multi-national advertising agencies depend on making money throughout their networks of agencies across the world in order to keep this organisational infrastructure in place. Much of that money comes from the local adaptation of the advertising originated centrally—i.e. adapting centrally produced advertising to work effectively in a local market. This is primarily achieved via a multi-level set of supplier client relationships (advertising agency/marketing services/production). More often than not, this complex communication matrix results in time intensive administration and in duplicate production being undertaken in the various local markets. These direct and indirect costs are ultimately paid for by the client organisations. In addition, this convoluted process severely restricts a client's speed to market, and has many associated hidden costs and agency mark-ups. Research shows that clients are often paying 50%+ more than they should be for pre- and post-production services and that it is not unusual for administration time to outweigh production time by a ratio of ten or fifteen to one, often resulting in delays in campaign implementation. As an example of the administrative intensity of conventional systems, consider the following typical process needed to order one existing advertisement to run in one publication:

| | |
|---|---|
| 1. | Client agrees media |
| 2. | Write fax to agency |
| 3. | Follow up phone |
| 4. | Account Manager opens Job No. |
| 5. | Write job start/copy client, fax |
| 6. | Communicate to production |
| 7. | Prepare estimate |
| 8. | Send estimate to Client |
| 9. | Explain estimate to client |
| 10. | Estimate approval |
| 11. | Negotiate copy date (late now) |
| 12. | Purchase order to supplier |
| 13. | Production commences |
| 14. | Proofs, checking, etc |
| 15. | Delivery |
| 16. | Invoice from supplier |
| 17. | Check against PG and estimate |
| 18. | Send to Finance |
| 19. | Enter on Finance System |
| 20. | Raise invoice to client, etc, etc |

This already extended process can be further complicated because of the following:

poor information flow constraints on the supply chain

time zone dependencies

the ease with which errors and delays can occur

the repetition of the above: typically 2,000 times a year or more

### SUMMARY OF THE INVENTION

In a first aspect of the present invention, there is a method of designing an advertisement by using digital media assets stored in a database in a computer system, in which the computer system allows the selection, assembly or modification of the digital media assets into a proposed advertisement on instructions from a client computer sent over a wide area network;

characterised in that the computer system also allows instructions from the client computer to initiate a delivery process for delivering pre-selected digital media assets to an entity responsible for producing a published advertisement.

An implementation of the present invention comprises a central web server as the computer system, storing tens or hundreds of thousands of media assets (such as still photographs, video, advertising text etc.) in a database which can be accessed over the internet by any number of authorised persons, each with a computer using a standard web browser. The central web server is programmed to allow not only the creation of the advertisement on-line through the selection, assembly or modification of appropriate media assets, with a realistic on-screen simulation of how the published advertisement will look, but also the actual delivery of the media assets to, for example, a magazine publisher or television station. By integrating the media asset delivery process into the on-line advertisement creation process, a fully integrated system is produced which greatly increases the efficiency of the management and production of advertising campaigns. The potential efficiencies are most dramatically realised in international advertising campaigns, where the simplified process possible with the above implementation speeds up the entire workflow, enhances accuracy and quality, makes central control of global advertising fast and efficient, and reduces overall production and administrative costs.

The term ‘computer system’ used in this specification, whilst in one implementation referring to a web server (or applicable components within a server based architecture) is not limited to that structure; it covers, for example, a computer system comprising multiple resources each having specialised tasks (e.g. one for media asset storage, another for handling the initiation of the delivery process to the magazine publisher, TV station etc.)

Delivery of the digital media assets can be through conventional delivery mechanisms (e.g. physical prints, video reels) or through entirely digital mechanisms. The delivery process is a particularly complex one to integrate fully into an on-line system and an implementation of the invention does so through sophisticated databases which hold (i) the advertisement deadlines for large numbers of different magazines, TV stations etc, (ii) the minimum delivery lead times, (iii) the technical printing or broadcast specifications and (iv) delivery addresses for the different magazines and TV stations etc.

Hence, this implementation allows the user to specify the physical or electronic media delivery address by selecting records from a database of recipients. Further, when selecting a delivery destination for an advertisement (e.g. a particular print publication or TV channel), the central database returns as a default to the user's computer the usual parameters for that destination (e.g. preferred advert size, language, colour or B/W, TV advert duration etc.) A choice outside of the default triggers an automatic e-mail to the central control authority, which may have veto rights.

As noted above, when selecting the desired date of advertising (e.g. publication month for print), the system checks against a database of minimum lead times to ensure sufficient time is available to meet individual media deadlines. The lead time is the minimum time needed to produce a deliverable for a publisher or broadcaster (e.g. artwork for a print advert; video tape for a TV advert), apply quality controls and complete the actual delivery. By using the minimum lead time database and the deadline database, the system can, knowing the current date, determine automatically if there is sufficient time to get a given piece of advertising into a specific publication/TV advertisement etc. Where there is not sufficient time, a warning notification is sent to the user's computer and the delivery can not be initiated.

The system also calculates automatically the cost of compiling the media assets to the required TV format for the specified destination (e.g. a PAL VHS tape etc.) by using a database of applicable costs. In this way, the total production costs for a piece of advertising can be calculated automatically. The system also allows time related production pricing; for example, production costs can be discounted where good notice is given, or surcharged for urgent matters.

The system includes a database with copyright information so that the user can check that images, music, talent or designs have copyright clearance. The system can also block ordering of advertisements or images outside copyright (or override any such blocking if necessary and appropriate).

An implementation includes the following additional features:

Prior approval for the initiation of the subsequent delivery processes can be required for specific individual users. This allows a central control authority to review the proposed advertisements and, on-line, authorise or reject the proposed delivery order, automatically causing appropriately worded emails to be sent to the relevant users and administrators of the system.

The system automatically displays advertising images or products which are compatible with user specified criteria (e.g. user, advertisement size, region, user language, colour etc.).

The system allows a user to select an image or advertisement and then automatically generates a list of products which are compatible with that image or advertisement.

The user can choose appropriate elements from the databases (such as logos, products, images, copy) and automatically build advertisements within predefined template guidelines.

The system can stop the user from assembling advertisements outside predefined criteria such as size, shape, combinations of elements.

The system can allow users to assemble compilations of commercials and videos and to add tides and then to preview and/or edit the compilation at their own computer prior to a possible order being placed on the system.

The system auto-generates e-mails:

Confirming an order to a user

To a central control authority for approval/veto

To an artwork studio with a script which specifies how the artwork is to be constructed

To a print/TV production company to assemble the high-resolution files or video.

The system allows only certain media assets to be made available to certain users.

Outside suppliers (e.g. an artwork studio) can readily post back to the central database an up to date version of what they are working on.

Outside suppliers can enter the status of the job they are working on and enter an airway bill number; users can then subsequently track the production status and monitor delivery progress without needing to re-enter the airway bill number.

Users with appropriate access authority can track orders of other users.

The system allows users to enter data regarding the end use of materials ordered allowing users with appropriate access authority to track the end usage of materials on a local, regional or global basis.

The system allows users to approve or not approve costs.

The system allows users to order adaptation kits of advertisements.

In another aspect, there is a computer apparatus, such as a server, programmed to enable any of the preceding methods to be performed. The server can host an ASP implementation of the invention.

In a further aspect, there is a client computer when operating with such a computer server in order to design an advertisement using the method of this invention.

In a final aspect, there is publication comprising an advertisement designed using the above inventive method. Further details of the invention are specified in the claims of this specification.

### BRIEF DESCRIPTION OF THE DRAWINGS

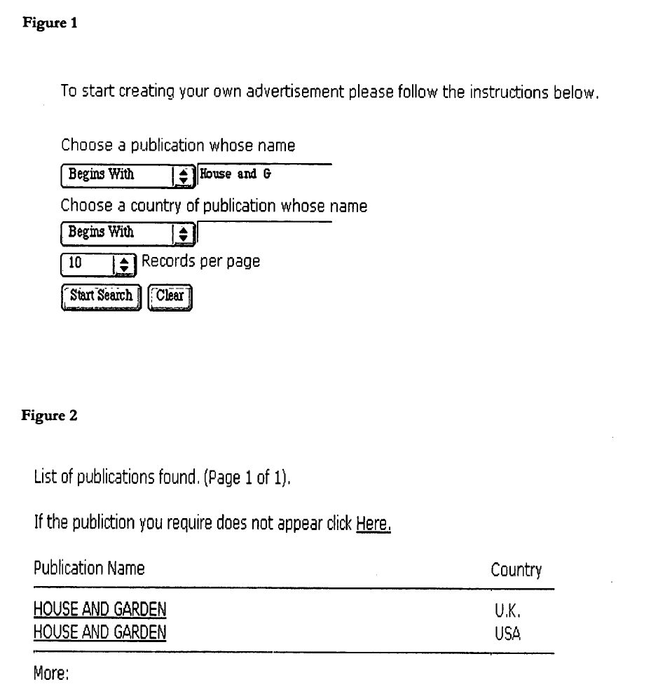

The invention will be described with reference to the accompanying FIGS. 1-12, which are partial screen shots of a web browser application being used to design an advertisement using digital media assets in accordance with the method of the present invention.

### DETAILED DESCRIPTION OF THE PREFERRED IMPLEMENTATION

This invention will be described with reference to an implementation from Adgistics Limited of London, United Kingdom: the Adgistics Advertising Management System (AMS).

AMS is a secure Internet-based front-end Advertising Management System (AMS) specifically designed to manage the marketing services co-ordination and production output for major advertisers. A customised AMS e-infrastructure is developed for each client linked to high-resolution databases containing repro and broadcast quality media asset files, backed up by efficient and cost-effective production and implementation. (Although a web-based ASP offering many of the features and benefits of AMS is possible with the present invention, enabling small and medium sized business access to efficiently design, order and deliver advertisements, AMS itself is in fact a customised service designed for a small number of high-end, multi-national advertisers.)

The AMS front end will allow any client with security clearance to access materials, and order them, for digital or conventional delivery anywhere in the world. AMS offers the following advantages, which will be expanded on later:

(i) savings on advertising and marketing-related production expenditure (which can approximate to an overall saving of 2-7% of a company's annual media expenditure)

(ii) reduction in the time taken to implement, execute and administer international advertising campaigns (days rather than weeks with regard to distributing TV transmission- or press-related copy and minutes rather than hours/days to create advertising artwork/film copy)

(iii) superior production quality achieved through using leading-edge production technologies (traditionally not used by advertising agencies who act as gatekeepers to advertisers).

The following is a step by step walk through for a user, in this case a watch retailer, wishing to use AMS to design an advertisement featuring a Patek Phillipe® watch and place that advertisement with a particular print publication. Because it is the watch retailers who bear a significant cost of this kind of advertising, it is they who decide the products they wish to advertise and in which magazines; however, they do so using only media assets (e.g. text and photographs) produced centrally by Patek Phillipe, and selecting their own choice of logo, following strict layout templates and under the ultimate control of Patek Phillipe.

The AMS system will allow the user to select:

Where and when the advertising is to appear

The advertisement the user wishes to use

The watch the user wishes to use

The logo the user wishes to use

The delivery address

To avoid delays and wasted production costs through errors or inaccurate orders the system has been configured so that:

It will only show advertisements that can be made to fit the size the user has chosen

It will only show watches that can be featured in the size and advertisement the user has chosen

It is not possible to order a watch or advertisement that are unsuitable for each other or for the publication size chosen

It is not possible to order an advertisement if there is not enough time to produce, quality control and deliver before the publication delivery deadline

To ensure that an order is produced correctly, the user must have, or generate during the course of the on-line interaction with AMS, the following information:

(a) Their user name, entry password and order password.

(b) The publication details:

(i) Name and Country of the publication the user wishes to advertise in. The system stores on a central database a full list of approved publications, allowing the user to simply select the desired publication(s). A user can also add a new publication to the central database list, although it is subject to central vetting and approval prior to being accepted.

(ii) The space size the user wishes to use (Full Page etc.). The system automatically knows the default sizes normally used for any particular publication; this data is again stored on a central database. A user can also add a new publication size to the central database list, although it is subject to central vetting and approval prior to being accepted.

(iii) Date of publication (i.e. the date on the font page) the user wishes to advertise in. The system includes a database with the publication dates of all approved publications; the user has generally only to select a particular date.

(iv) Whether the user wants Colour or Black and White advertising.

(v) The delivery deadline—the system will not allow less than 5 working days, plus courier time for completion of orders. The system is again programmed with the delivery deadlines covering most circumstances.

(c) The Advertisement

The user will need to choose the advertisement it wishes to use, namely:

(i) The advertisement design and language

(ii) The Watch (or indeed any other kind of product) it wishes to feature

(iii) The logo it wishes to feature

(d) Delivery address

The user will need to select whether delivery is to the Publication, Retailer, or Somewhere else.

The following is a step by step guide through the actual process.

1. The user enters the AMS web site via their PC browser, inputs their user name and password and clicks ‘Login’.

2. The user clicks the ‘Create a new advertisement’ option which is displayed.

3. The user enters the name of the publication it wants to advertise in as a search query. The search menu screen is shown in FIG. 1.

4. A list of publications matching the search query is displayed. The user selects the publication it requires from the list, which is shown in FIG. 2.

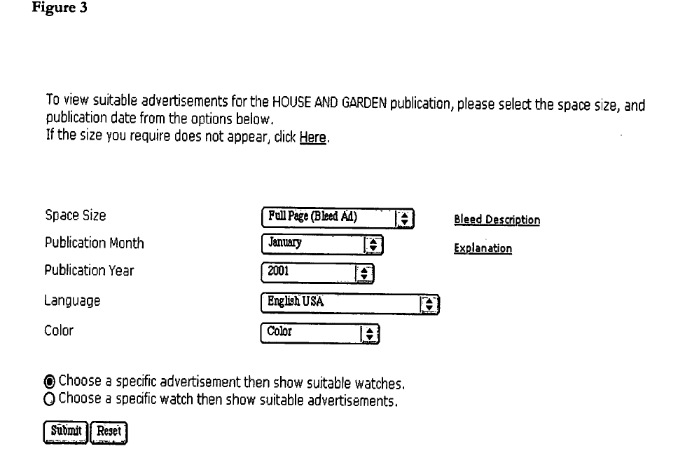

5. The user selects the publication details from the options, as shown in FIG. 3 (i.e. the space sought, the publication date, the language, the colour). Note: It is not possible to order an advertisement if there is not enough time to produce, quality control and deliver before the delivery deadline. Patek Philippe specify 5 working days, plus courier time before the publication deadline for this.

6. The user also chooses whether it wants (a) a specific advertisement (i.e. copy and photograph) and for the system to automatically show suitable watches or (b) a specific watch and for the system to automatically show suitable advertisements.

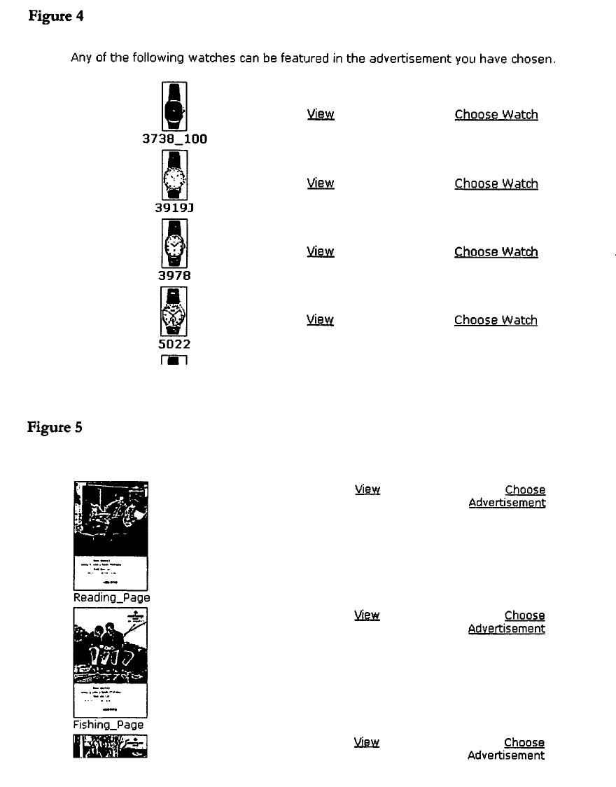

7. If (a) is chosen, the system will show (see FIG. 4) only the watches that can be featured in the chosen advertisement. By selecting Choose Watch, the user chooses the watch that will be used in the advertisement.

8. If (b) is chosen, then the system will show (see FIG. 5) only the advertisements that can fit the chosen space size. The user now clicks on Choose Advertisement to choose the advertisement that it wishes to use.

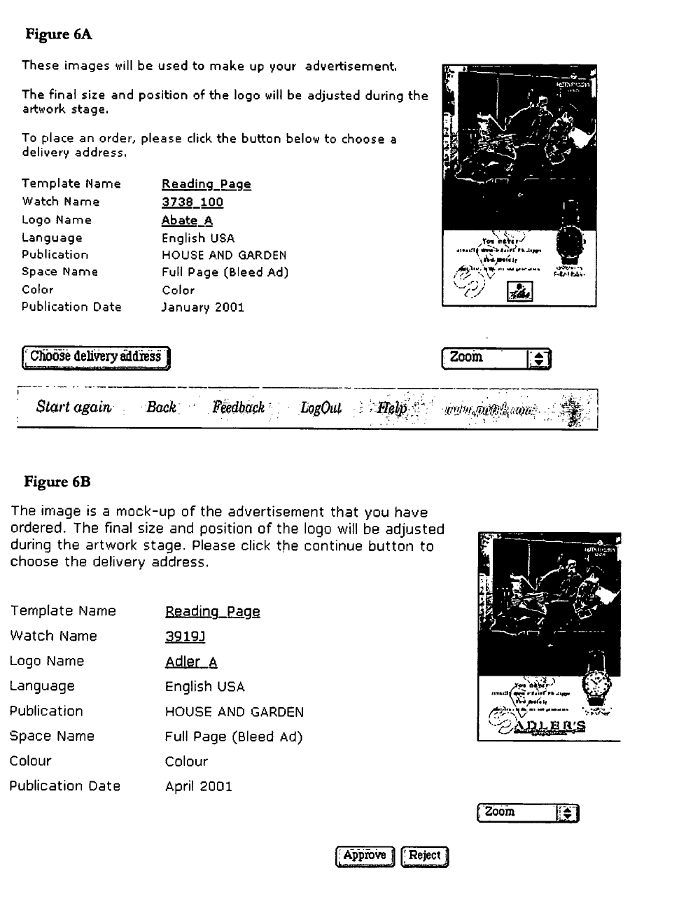

9. The system will now build and download (see FIG. 6A) to the user a visual of the advertisement. The user finally checks all the details and uses the ‘back’ facility at the base of the page if any changes are needed. A central control (e.g. central advertising agency, corporate client etc.) is also sent an automatically worded email describing the choice of publication, publication date, size, advertisement, product, logo and a job number allowing the recipient to view on-line a copy of the proposed advertisement and may have veto/approval rights, as shown in FIG. 6B.

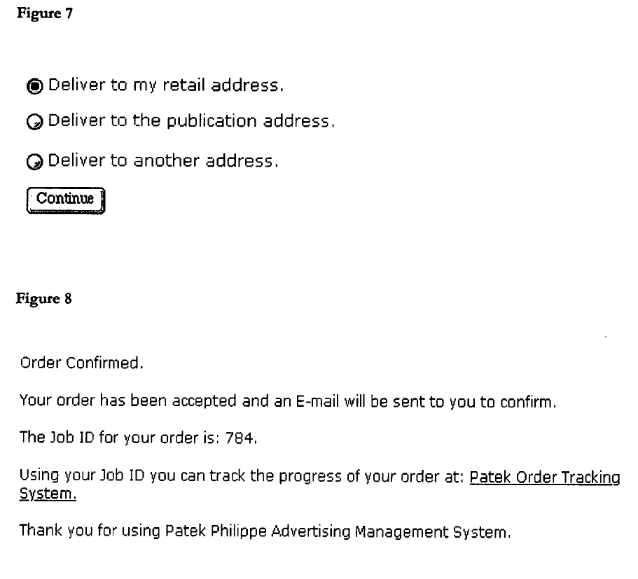

10. The user now clicks ‘Choose delivery address’ and the FIG. 7 menu appears. The user now chooses a delivery option and clicks ‘Continue’. Note: If the user has not chosen delivery to the publication it may enter a delivery address now.

11. After the user has completed the delivery instructions, it enters an order password.

12. The order has now been completed. A number of automatically worded and addressed emails are sent to the user to confirm, to the central agency and client, to production suppliers and to the system manager, as shown in FIG. 8. The user should note the Job ID number. The progress of the order can be tracked on-line, as explained above.

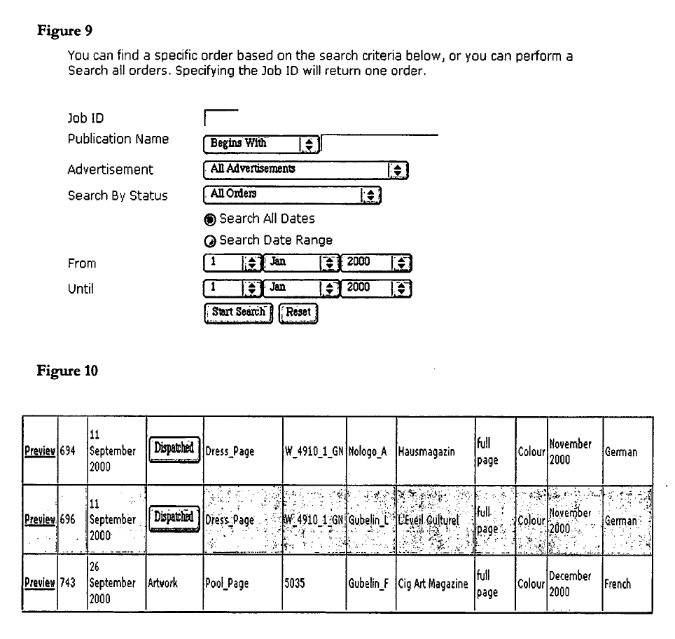

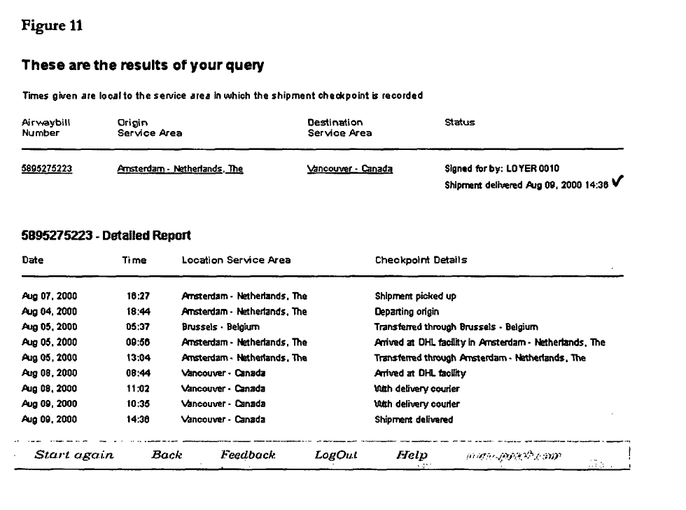

Tracking an order: a user can access the order tracking system immediately after logging in via a search screen as shown in FIG. 9. FIG. 10 shows the deliver details; clicking on the ‘Dispatched’ option button leads to the detailed view in FIG. 11. This screen shows the delivery status of the order.

Adding a new publication: if the user wishes to add a new publication to the system it must have the following information:

(i) A contact name at the publication, and the country of publication

(ii) A telephone number for the contact name at the publication

(iii) A fax number for the contact name at the publication

(iv) The dimensions (in millimetres or inches) of the space the user has booked

(v) Whether the publication is a newspaper or magazine; whether it is published daily, monthly etc.

The process is as follows:

1. The user logs in to the system in the usual way and then clicks: Create a new advertisement

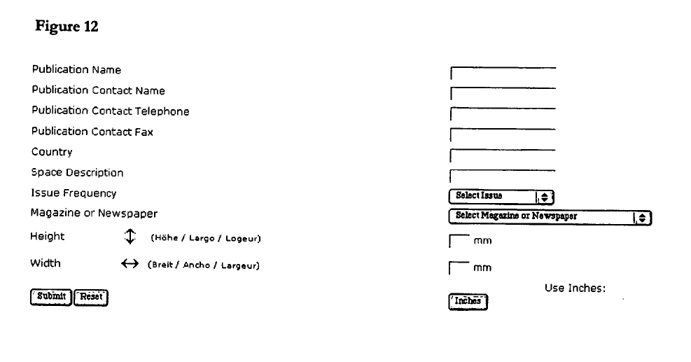

2. The user enters the name of the publication it wishes to enter (see FIGS. 1 and 2). The system will then search to ensure it has not already been entered by someone else. The user can click ‘Here’ on the FIG. 2 screen to add a new publication. The user now enters the publication details on the FIG. 12 screen and clicks ‘Submit’ to continue the order process. If the user has entered an unusual size or shape of space, it is possible that the system will not hold any advertisements that will fit. The system will then inform the user that there are no advertisements which are available to fit the entered size.

The user can add a new size in a similar way.

Details of added publications and sizes are automatically emailed to the corporate client and agency, and production supplier.

### Key Benefits of AMS

The Adgistics AMS architecture combines the efficiency of an Internet front-end advertising logistics e-infrastructure with proprietary cost saving back-end production technology:

the Internet front-end allows international clients 24-hour access to digitally archived marketing materials such as photographic assets, press advertisements, posters television commercials and direct mail. Today, access to these materials is constrained by the need to work through a series of intermediaries where management systems largely rely on manual systems and telephone/fax communications.

AMS significantly reduces implementation times for advertisers, addressing their ‘need for speed’ whilst reducing their own administration and handling costs. Additionally, by making materials more easily available to a wider range of users, clients will enjoy an improved return on their investment in creative ideas.

Advertisers will be able to manage the creative and artwork approval cycle using a graphical interface allowing tailored routing of the approval chain.

AMS will provide a digital archiving service for advertising materials using proprietary colour management technology.

The latest technology will uniquely allow still images, press advertisements and print design materials to be stored in RGB format and converted automatically to any required specification.

This delivers several unique benefits:

the number of files that need to be stored for any given press advertisement is at least halved, saving time and costs.

better quality reproduction in each press publication.

the scanning process, which traditionally requires human intervention, is managed through technology rather than trial and error.

raw RGB scans are automatically converted to CMYK publication specification without the additional cost of manual intervention.

AMS delivers a TV back-end, allowing clients access to, and on-line ordering of, moving image material. Ultimately clients will be able to arrange electronic delivery of broadcast quality material direct to post-production facilities and broadcasters. In the meantime, AMS will deliver a cost-effective and high-speed service manufacturing one off and bulk copies for immediate delivery via courier. It is envisaged that one off copies will be ready for despatch within one hour of ordering via the AMS system.

The system allows clients to monitor advertising activity more easily than is currently possible, creating the link for advertising activity to be more closely compared to sales performance.

### Client Benefits: On-Line Marketing Management

Clients using AMS can:

make new creative work available worldwide within minutes

view, comment on, download and print low resolution reference materials, to include photography, press ads and TV commercials

order high resolution photographic images, repro-ready press ads and TV material up to broadcast quality, correctly formatted, colour balanced etc., and arrange delivery direct to publication or station

control costs. On-line estimating and cost approval (and later, on-line billing) replaces manual calculation, typing and paper based cost control methods

campaign management. Track who is ordering what, where and when

implement media more flexibly. Improved production delivery times will allow clients to be more versatile in media buying and management

### Client Benefits: On-Line Cost Management and Savings

Clients using AMS enjoy cost savings in the following:

press production

TV Production

creative work. By making creative work more widely and immediately available, clients will reduce the need for locally created campaigns

transactions: Conservatively, 10% of junior and middleweight marketing personnel time

media costs: Ability to exploit late booking opportunities will allow clients to optimise their use of “distress” short-term space

Further advantages are:

improved return on investment in centrally generated creative assets

on-line browsing delivers instantaneous access to paid-for assets, without phone calls, faxes, or response delays. AMS allows wider and more frequent use of advertisements and images, and reduces duplication of photography and replication of creative work

### Client Benefits: On-Line and Real Time Management

Implementation times reduced. With AMS, worldwide distribution of campaigns is cut from two weeks plus to less than one day

Advertising production time cut from weeks/days to minutes with AMS

On-line ordering of production materials reduces time from initial request to delivery by weeks in AMS

### Client Benefits: Knowledge

Clients who today cannot tell what work is running where, can call up reports of who has ordered what, where and when with AMS

### Client Benefits: Control

Clients can make their work available on chronological, campaign, product category, user specific and geographical basis

### AMS Features

AMS offers a wide range of solutions to problems facing international advertisers:

Initially, these offerings will include the following on-line services:

visual asset management

campaign materials ordering and fulfilment

campaign implementation management

automated artwork production

automated pre-press production

Going forward, AMS will include:

integration of Media and Campaign Implementation processes

on-line management of media buying

delivery of press advertising to publications via telecom/Internet

delivery of TV commercials to broadcasters via telecom/Internet.

automated TV editing

### Visual Asset Management

AMS delivers time, cost and quality benefits by exclusively uniting Internet administration with RGB workflow and colour management technology. Alone, this can deliver savings of 50% or more in the area of press post-page-make-up production.

Users will be able to quickly download images in low resolution allowing them to proceed with artwork production whilst waiting for high-resolution images to follow shortly afterwards. In this way access to images will be possible within minutes rather than the days or weeks current logistics dictate. On-line delivery via the web and services including Wamnet, Vio and ISDN will eliminate the need for expensive low quality photographic duplicates and couriers.

Clients wishing to order TV commercials will with AMS be able to order on-line and then receive broadcast quality images electronically for a relatively small additional outlay in hardware.

### Campaign Materials Ordering and Fulfilment

Clients using AMS will be able to browse and order campaign materials directly from the AMS web site for delivery direct to printer, publisher or broadcaster. Current industry practices allow the supply chain to be constrained by poor information flow. By allowing clients direct access to the manufacturing stage of the supply chain, delivery times will be significantly faster, whilst lowering cost by removing the need for intermediaries' profit requirements.

### Campaign Implementation Management

The on-line creative and production ‘Inform and Approve’ system will enable international advertisers to easily manage the process of approvals that today is largely carried out by phone, fax and courier. By incorporating a graphical interface that easily marks out not only ‘who’ but also ‘when’, clients will more easily be able to control, track and accelerate the approval viewing process. This will speed up the delivery of advertising, assisting clients in getting their message to market earlier, whilst making it easier for clients to exercise control over local adaptation of campaign materials and brand consistency.

The on-line browse and order function will allow marketing headquarters and local offices to distribute approved campaigns on a global basis within minutes. Traditionally, this process has been slow and inefficient, and has been carried out by using ad kits, videotape and courier, often delaying implementation by weeks or months. Clients wishing to control who sees what and when (for example, during a phased global marketing launch) will be able to manage the process via a simple on-line interface. Additionally, changes to content can be instantly communicated on a global basis.

AMS enables marketing headquarters to monitor advertisement usage and provide data for comparison to sales figures.

### Automated Artwork Production

AMS allows clients to assemble print and press advertising artwork via a ‘click and see’ artwork assembly system, delivering instant on line viewing, revision and approval possibilities. This will deliver significant cost and time benefits.

It is envisaged that this system will extend to automated editing of broadcast materials to allow real time addition of language end frames to commercials.

### Automated Pre-Press Production

AMS will offer automated pre-press production delivering further speed quality and price benefits.

### Automated TV Assembly and Titling

AMS allows user to assemble compilations of commercials and specify wording for tides with instant on-line viewing revision and approval possibilities.

1. A method of designing an advertisement by using digital media assets stored in a database in a computer system, in which the computer system allows the selection, assembly or modification of the digital media assets into a proposed advertisement on instructions from a client computer sent over a wide area network;
characterised in that the computer system also allows instructions from the client computer to initiate a delivery process for delivering pre-selected digital media assets to an entity responsible for producing a published advertisement.

2. The method of claim 1 in which information is obtained from one or more of the following databases to enable the delivery process:
(i) a database with the advertisement deadlines for several such entities;
(ii) minimum applicable delivery lead times; and
(iii) delivery addresses for several such entities.

3. The method of claim 2 in which, when a user selects a delivery destination for an advertisement, a database returns as a default to the client computer pre-defined parameters for that destination.

4. The method of claim 3 in which choice by the user outside of the default parameters triggers an automatic e-mail to a central control authority.

5. The method of claim 2 in which, by using the minimum applicable delivery lead time database and the advertisement deadline database, the computer system can, knowing the current date, determine automatically if there is sufficient time to get a given advertisement into a specific print, TV or other media destination.

6. The method of claim 5 in which, when there is not sufficient time, a warning notification is sent to the client computer and the delivery either (a) can not be initiated or (b) the user can accept responsibility for the risk of late delivery and go ahead to place an order.

7. The method of claim 2 in which the computer system calculates automatically the cost of compiling, outputting, and delivering the media assets to a required TV, Poster, Print, Press, Web or other format for a specified destination by using a database of applicable costs.

8. The method of claim 7 in which the computer system tracks in a database time related production pricing in which production costs can be discounted where good notice is given, or surcharged for urgent matters.

9. The method of claim 1 in which a database with copyright information is accessible to the computer system so that the user can check that images, music, talent or designs have copyright clearance.

10. The method of claim 1 in which prior approval for the initiation of the subsequent delivery processes can be required for specific individual users.

11. The method of claim 1 in which advertising images or products which are compatible with user specified criteria are automatically displayed on the client computer.

12. The method of claim 1 in which when a user selects an image or advertisement there is automatically generated on the client computer a list of products which are compatible with that image or advertisement.

13. The method of claim 1 in which the user can choose appropriate media asset elements from the media asset database and advertisements are then automatically built by the computer system within predefined template guidelines.

14. The method of claim 13 in which assembling advertisements outside predefined criteria such as size, shape, combinations of elements can be automatically prohibited by the computer system.

15. The method of claim 14 in which a user can assemble a compilation of commercials and videos, type in and add titles and then preview and/or edit the compilation using the client computer prior to a possible delivery order being placed.

16. The method of claim 1 in which auto-generation of e-mails occurs in one or more of the following circumstances:
(i) When an order is to be confirmed to a user;
(ii) When a central control authority needs to exercise approval/veto;
(iii) When an artwork studio requires a script which specifies how the artwork is to be constructed;
(iv) When a print/production company needs to assemble high-resolution files.
(v) When a TV production company needs to add titles and/or assemble video files

17. The method of claim 1 in which only certain media assets are made available to certain users.

18. The method of claim 1 in which outside suppliers can post back to the computer system an up to date version of what they are working on.

19. The method of claim 1 in which outside suppliers enter the status of the job they are working on and enter an airway bill number and users can then subsequently track the production status and monitor delivery progress without needing to re-enter the airway bill number.

20. The method of claim 1 in which a user with appropriate access authority can track orders of other users.

21. The method of claim 1 in which a user submits data to the system regarding the end use of materials ordered, allowing other users with appropriate access authority to track the end usage of materials on a local, regional or global basis.

22. The method of claim 1 in which a user is allowed to approve or not approve costs.

23. The method of claim 1 in which a user is able to order adaptation kits of advertisements.

24. A computer system programmed to enable any of the preceding methods to be performed.

25. The computer system of claim 24 comprising at least one server.

26. The computer system of claim 25 in which the server acts as an application service provider.

27. A client computer when communicating with the computer system of claim 24 to design an advertisement using digital media assets.

28. A publication comprising an advertisement designed using the method of claim 1.

29. The publication of claim 28 being in one of the following formats:
(a) print
(b) television
(c) web.
